(19) United States
(12) Patent Application Publication
(10) Pub. No.: US 2021/0241294 A1
(43) Pub. Date: Aug. 5, 2021

(54) DYNAMIC GROUP BUYING AND PRODUCT RE-PRICING USING MACHINE LEARNING METHODS

(71) Applicant: ULTA SALON, COSMETICS & FRAGRANCE, INC., Bolingbrook, IL (US)

(72) Inventors: Michelle A. PACYNSKI, Bolingbrook, IL (US); William P. KRAMER, Bolingbrook, IL (US); Chatura SAMARASINGHE, Bolingbrook, IL (US); Brian SATHIANATHAN, Bolingbrook, IL (US)

(21) Appl. No.: 17/167,894

(22) Filed: Feb. 4, 2021

Related U.S. Application Data
(60) Provisional application No. 62/969,727, filed on Feb. 4, 2020.

(51) Int. Cl. G06Q 30/02; G06N 3/04; G06N 3/08; G06Q 50/00; G06Q 30/06

(52) U.S. Cl. CPC G06Q 30/0202; G06N 3/04; G06N 3/08; G06Q 30/0206; G06Q 2230/00; G06Q 30/0605; G06Q 30/0223; G06Q 30/0235; G06Q 30/0201; G06Q 50/01

(57) ABSTRACT

A dynamic group buying system that utilizes a neural network-based machine learning system to generate an optimized price campaign for a product or a product bundle while considering human product seller set bounds consisting of a variable combination of reserve quantity of product, minimum sales price and list price, duration of the campaign, number of levels and maximum price. As an extension of the machine learning capabilities, the system includes a recommendation system that aids the seller to make informed, decisions on factors such as what product(s) bundle should be added to the campaign, what is the ideal time and duration of the campaign, for example. The system is designed to optimize the campaign creation capabilities by analyzing the past product campaigns.

### PRIORITY CLAIM

This application claims priority under 35 U.S.C. § 119(e) to U.S. Provisional Application Ser. No. 62/969,727, filed Feb. 4, 2020, which is expressly incorporated herein by reference in its entirety.

### FIELD OF THE INVENTION

The invention is related to the field of group buying, dynamic repricing and crowd optimized pricing using machine learning technologies.

### BACKGROUND

Current group buying systems are not designed with the retail customer in mind. Also, the existing systems do not provide any functionality to adjust the prices based on factors such as customer demand. There are several online repricing systems implemented by online retailers however, these systems lack the group buying capabilities and have several drawbacks. The current online repricing systems tend to ‘compete’ with other online retailers and their repricing systems. As a result, the retail customer might be at a distinct disadvantage as these automated systems' bias to the retailer and often prices change as a result of competition. While more customers get to know about these systems, the customers tend to develop a negative outlook toward these online retailers as price adjustments can be seen as unfair or based solely at the retailer's discretion.

Most of the online repricing systems are based on factors such as competing prices by other sellers and product sell history. The customer engagement in repricing systems is low as the repricing happens implicitly. The customer feels that they have no control in this and tend to feel less connected to the brand. Customers tend to form emotional connections with the brands they love, and customer engagement plays a key role. It can be assumed that systems which are more interactive and promote social connections tend to have higher brand loyalty.

The sales figures of a product can dramatically increase or decrease based on the social presence of the brand. Social media is a strong driver of sales in online retailing and can give rise to massive trends, create brand awareness and be a platform for free advertising. When analyzed accurately, social media channels provide a real-time view of customer preferences which enables e-commerce platforms to dynamically change its product listings and prices based on real time buying habits of the user to maximize sales.

Gaming has also become a huge trend today so much so that gamification has seeped into common day-to-day applications. From simple quizzes to more complex systems, smartphone applications and web applications have successfully leveraged gamification to get to know more about the customers and provide them with personalized products and experiences. Using various Machine Learning technologies now it's possible to understand a customer's reaction with a given product and their individualized and tribe-based reaction to the price. This invention capitalizes on such technologies to provide an optimized and advantageous pricing scenario for the customer.

These factors provide a unique opportunity to create a gamified, socialized system optimized by Machine Learning which combines group buying and product repricing targeted towards online retail customers. This system will promote collaboration among customers and will avoid any form of competition.

### SUMMARY

In accordance with the present disclosure, a group buying system provides tor a dynamic buying platform.

In illustrated embodiments, dynamic group buying is a computer implemented system that utilizes a neural network-based machine learning system to generate an optimized campaign for a product or a product bundle while considering human product seller set bounds consisting of a variable combination of reserve quantity of product, minimum sales price and list price, duration of the campaign, number of levels and maximum price.

As an extension of the machine learning capabilities, the system includes a recommendation system that aids the seller to make informed decisions on factors such as what product(s) bundle should be added to the campaign, the ideal time and duration of the campaign. The system is designed to optimize the campaign creation capabilities by analyzing the past product campaigns.

In illustrated embodiments, the system also includes a buyer process in which buyers that are interested in a product pledge to purchase the product at a set price in a price tier. If the number of buyers reaches the minimum number of buyers set by the seller in the price tier, then the goods are sold to the buyers who pledged at the price set in the set discount price tier. When the number of pledges increase and reach the set pledge goal of the discount tier, the dynamic group buying program will advance the product to the next tier which contains a new pledge goal and a better (more desirable) discount.

In illustrative embodiments, if a buyer cannot find an item in the optimized pricing campaign, the dynamic group buying program allows a user to recommend a product to be added as an item in a future optimized pricing campaign. When a user makes the initial recommendation, the recommended product is added to a new page where all product recommendations for optimal prices are posted and voted on. The system allows other users to vote for the added products at an optimal price. If the product is added onto an optimized pricing campaign, the user will be sent a notification and will automatically be added as a pledge for the product.

Additional features of the disclosure will become apparent to those skilled in the art upon consideration of the following detailed description of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is flow diagram of a seller (vendor) process;

FIG. 2 is a flow diagram of a buyer process;

FIG. 3 is a flow diagram of a buyer voting process;

FIG. 4 is a graphical illustration of a webpage where a seller creates a campaign using dynamic group buying;

FIG. 5 is a graphical illustration of a webpage where a seller adds a product to a campaign;

FIG. 6 is a graphical illustration of a webpage display of active campaign where a buyer pledges to purchase a product at a discounted price;

FIG. 7 is a graphical illustration of a webpage display of a main campaign pledge page for buyers;

FIG. 8 is a flow chart that illustrates the dynamic pricing steps;

FIG. 9 illustrates the communications sent to successful participants enclosing a coupon code;

FIG. 10 shows a system in accordance with the present disclosure, in simplified block diagram;

FIG. 11 is a graphical illustration of a webpage display showing a full desktop landing page as an active campaign is in progress;

FIG. 12 is a graphical illustration of a mobile device display of an initial landing page as an active campaign is in progress and shows limited information compared to FIG. 11; and

FIG. 13 is a graphical illustration of a mobile device display of a completed campaign.

### DETAILED DESCRIPTION

Embodiments relate to a dynamic group buying (dynamic group buying) apparatus; a computer implemented system that utilizes a variable combination of reserve quantity, minimum price and a list price (maximum price). A specific product seller can log into the system and define these variables for a product. Once these variables are defined, the system will generate an optimized price campaign for that specific product.

The optimized price campaign for a product represents the core machinery of the dynamic group buying apparatus. An optimized price campaign contains an expiration time and a certain number of discount levels (discount tiers) both generated by the system. A discount tier consists of a discounted price of the product and stock amount (pledge goal) derived from the reserve quantity.

The core machinery for the optimized campaign creation process includes a machine learning system employing a neural network-based regression model in conjunction with the quantity demand function to determine the price for each tier. The machine learning system utilizes product/product-bundle specific parameters including the purchase trends and pricing history of the specific product/bundle. The system introduces a product specific parameter called interest velocity, which is the user's interest gained, lost or held or a specific period of time. The machine learning system also considers non-product-specific parameters such as the time of the year, special holidays, meteorological seasons, for example.

The machine learning system also aids the sellers in deciding the optimum seller provided parameters such as the combination of product/product-bundles, campaign duration and the ideal time to start the campaign. This is done by utilizing the neural network based regressor to project the performance and popularity of a campaign based on the gathered parameters. The system is able generate varied campaign simulations based on the seller provided parameters allowing sellers to make informed decisions.

The machine learning system also includes machinery for self-learning. The system analyzes the previous product campaigns, analyzes which configurations yielded better results based on the parameters and optimizes its campaign creation as well its recommendation capabilities.

The system introduces an approach to buying called ‘pledging’. This is the primary method of customer engagement in the system. In this approach, the buyer does not outright buy the item; rather, they agree to buy the product at the end of the campaign at an optimized price. Buyers can initiate a ‘pledge’ in a number of ways. First, they can leverage the Internet to identify products that they are interested in pledging at a “fair” price or one they propose. The dynamic group buying system has the capability to accumulate buyer interests at similar pledges, thereby dynamically growing the reserve quantity. Alternately, buyers can browse a list of sellers proposed items with associated reserve pledges and quantities to acknowledge interest in participation. Lastly, they can propose their own list of products with an associated pledge and quantity allowing the buyer to solicit demand in order to validate the reserve quantity and pledge. All interactions during the pledging process are captured by the machine learning algorithms and leverages current and subsequent interactions to optimize the price.

The system is setup in a way that when an optimized price campaign is activated, the price of the product associated with the campaign has the lowest discount possible (out of the discount tiers). Initially, a buyer will pledge to the campaign. If a sufficient number of customers pledge for the item and they reach the pledge goal, they qualify for the next discount tier which results in an optimized price. The idea is that, as the number of pledges for a product grows, the system will optimize the price even further. This optimization is performed via a machine learning algorithm. Hence, it represents a system, which encourages more customers to participate to receive a product an optimal price.

In dynamic group buying, buyers are not competing with each other or with the seller, as the objective is to grow the buying group to achieve the pledge goal thereby securing the optimized price offered. Even more powerful and affirming, the system will have a certain level of integration with social media platforms, SMS texting, and email, to allow pledges to encourage other pledges to participate in the optimized price campaign as higher numbers increase the discount applied on the item. For the buyer, getting another buyer to pledge has the effect of affirmation of worth without the stress of competition.

The use of social media shares acts as a non-user specific parameter tracking to the assess the performance of live campaigns. This metric is valuable in assessing the real-time popularity or the interest velocity of the product and the product campaign and is a highly valuable parameter to tune the machine learning system to generate better optimized campaigns as well as better campaign performance simulations.

Sellers also have flexibility in the way in which they participate in dynamic group buying. Sellers can develop a list of products and associated pledge and quantity combinations enabling the sellers to achieve a consistent rate of return by lowering the price but raising the quantity in order to maintain overall profitability. The predefined list of reserve quantity and pledge combinations for a particular product can be static or dynamic. In a dynamically driven seller reserve pledge and quantity combination product group, the reserve pledge is derived based on a seller specified profitability target. In this form of seller participation, the dynamic group buying campaign engine drives the pledge based on the demand or number of interested buyers at various intervals over the course of the campaign and the specified seller profitability target. The pledge can be raised or lowered to meet demand while ensuring the seller's profitability target is achieved.

Additionally, the dynamic group buying apparatus will provide the ability to tag specific items as scarce or special items. When a very high demand is experienced as determined by the dynamic group buying apparatus, the pricing algorithm will leverage machine learning approaches to make a decision to increase the price amount that was initially posted for that product. The price tiers will be updated accordingly. The price is a function of demand and the demand is defined as a normalized function of time and stock.

The technique used is a machine learning adaptation of the inverse demand function. Initially, the algorithm will create an exponential distribution, or a machine learned sequence based on time duration of the campaign. Then a non-linear function is applied to locate a certain number (based on number of price tiers) of ‘time points’ (discrete time values). These time points are used in a function of stock and time to define the pledge goals for each price tier. Finally, the pledge goal values (and a few other variables) will be applied to the inverse demand function. This function may be represented and predicted via a neural network-based regression model in a supervised manner or via other forms of classifiers with prior training data to predict the price values for each tier.

In addition, sellers have the opportunity to review the offers of buyers and determine if they want to participate in the seller initiated dynamic group buying campaign by becoming the supplier of the products for the proposed reserve pledge and quantity should the campaign be successful. Ultimately, when the optimized price campaign closes, the highest discount unlocked will be given to all the pledgers who enrolled to buy the product. This gamification of crowd-driven optimized pricing will allow manufacturers to introduce items to consumers with less marketing cost. Also, the system will allow the sellers to quickly estimate the demand of a product and draw insights about users buying habits and product trends.

Invigorating the manufacture of items due to reduced risk is another benefit that the dynamic group buying apparatus has targeted. Planning the manufacture of items with a known economy of scale is a fundamental consideration for manufacturers introducing new items. A type of campaign for a future item is part of the dynamic group buying apparatus. Manufacturers can introduce items with less marketing cost and risk by setting a reserve quantity that provides an economy of scale. Additionally, the dynamic group buying has inherent marketing capabilities since the apparatus encourages buyers to share product items in social media for better pricing.

For the retail seller, the apparatus provides an efficient means of clearing wholesale merchandise. Both wholesale and introductory items are sold without risk of having their customer base associate their business with the stigma of unfairness associated with the current forms of online re-pricing systems.

In addition to pledging, buyers have the ability to propose products of their liking with an associated “fair” price to be added as an item for a future optimized pricing campaign. The proposed products will be hosted on a web page accessible to all buyers where they can vote on the proposed products to be added to future optimized pricing campaigns.

The voting mechanism can be used as a metric to estimate the demand for specific item as well as a crucial parameter for the machine learning based campaign creation system. Sellers have the opportunity to review the voting metrics and determine if they want to create an optimized pricing campaign. If the demand is high for a certain product with a substantial discount, the sellers can still achieve consistent rate of return by lowering the price but raising the quantity in order to maintain overall profitability. In this form of seller participation, the dynamic group buying pricing engine drives a discount agreed by buyer and seller based on the demand or number of interested buyers.

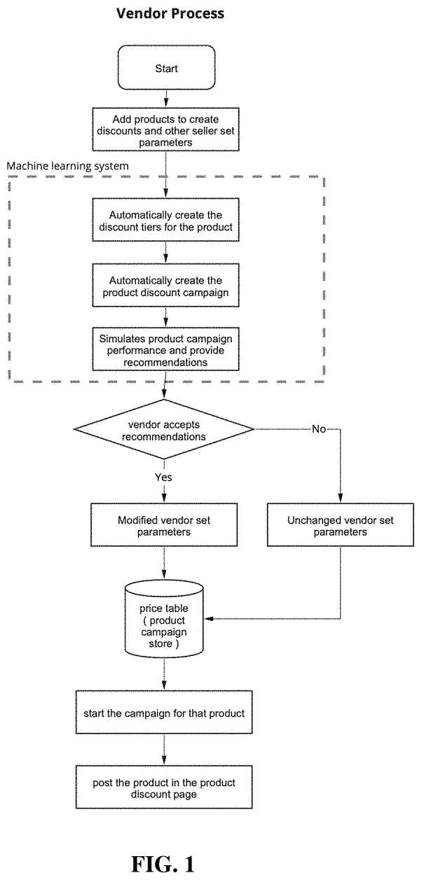

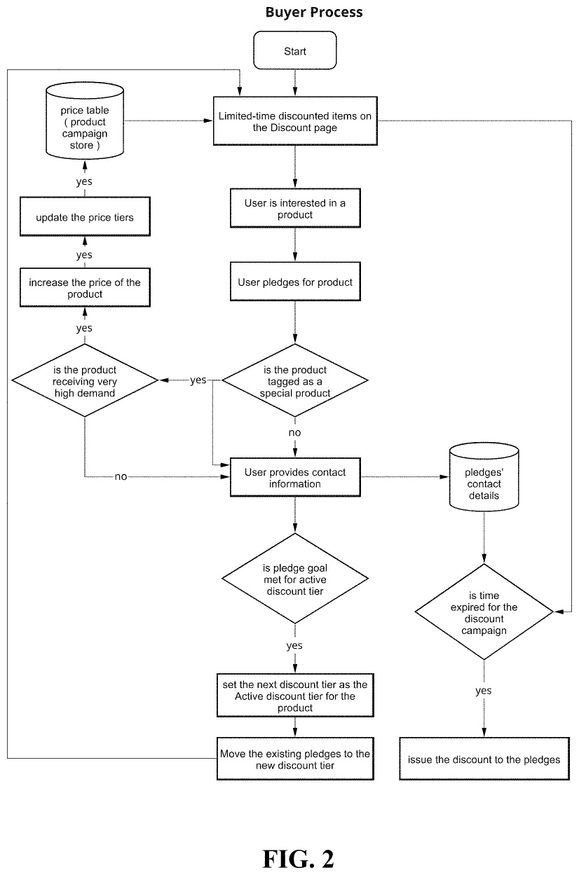

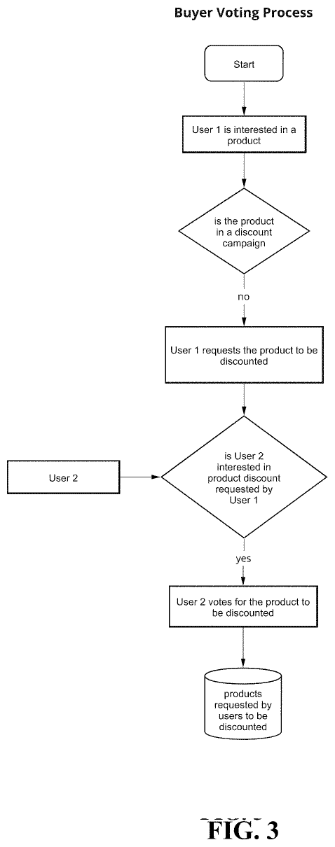

The voting capability will improve user engagement among users and help foster a community of users/buyers in group buying. The flow diagrams in FIGS. 1-3 represent exemplars of the dynamic group buying system in three processes. The diagrams describe the concept and the flow of data when a seller submits a product to be added to the optimized pricing campaign (FIG. 1—Seller process), when a potential buyer is interested in a product (FIG. 2—Buyer process) and, when a potential buyer wants to recommend a product for an optimal price (FIG. 3—Buyer voting process)

### Seller Process

FIG. 1 illustrates the seller's (vendor's) process and the steps taken by a seller to post a product to be added to an optimized pricing campaign. Initially, the seller will identify one or more products that is deemed suitable for a discount. Then, the seller will specify several variables. These variables are as follows: the duration of the optimized pricing campaign, the number of discount levels possible, the total product stock amount allocated to be discounted (total pledge goal) and the lowest price the product can be discounted (minimum price).

Upon the submission of the parameters, the campaign creation algorithm creates an optimized pricing campaign using supervised machine learning models. Even though the system uses machine learning algorithms it is also protected by a strong rule-based guard rail system to stay within the parameters set by the parties. The optimized pricing campaign contains a set of discount levels also known as discount tiers where each level contains a specific discount value and a set number of pledges needed to reach the next discount level (pledge goal). The campaign creation algorithm uses the variables provided by the sellers to establish boundaries when setting increments/decrements and allocating stock values (pledge goals) ensuring that the algorithm will not misbehave in its task.

After the campaign is generated, the system provides the seller a projection of the campaign performance based on the provided parameters and some recommendations to tune the seller provided parameters for a better optimized campaign. Based on the response, the seller can either try to modify the parameters accordingly or proceed with the original parameters.

### Buyer Process

FIG. 2 illustrates the buyer process, which begins with the discounted products showcased in the optimal Price page. At a start of a campaign, a product is in its lowest campaign tier, which contains the lowest discount. When a user/buyer is interested in a product, the user will pledge for the product by providing their contact information. The user's expectation is that they will be able to purchase the product at a minimum for the initial optimal price.

When the number of pledges increase and reaches the set pledge goal of the discount tier, the dynamic group buying program will advance the product to the next discount tier, which contains a new pledge goal and a better discount. The dynamic group buying will provide several social media tools to share the product optimized pricing campaigns to attract more pledgers, which will translate to potential buyers.

If the product is a tagged as a special product and if the dynamic group buying program senses a very high demand, the items will get repriced to a higher value which will affect the new pledges for the product. When the time allocated for an optimized pricing campaign expires, the dynamic group buying program will check the last active discount tier of the campaign and issue the optimal price to all the pledges of the campaign via a communication media such as email or text messaging. Pledges who are notified of the discount in some embodiments have the option of purchasing the product. In other embodiments, pledges are required to purchase the products at the end of the campaign.

### Buyer Voting Process

If the buyer cannot find an item in the optimized pricing campaign, the dynamic group buying apparatus provides the functionality for users to ‘recommend’ the product to be added as an item in a future optimized pricing campaign. When a user makes the initial recommendation, that product gets added to new a page where all the product recommendations for optimal prices are posted. The duration of how long a product should exist on the voting page can be decided by campaign administrators.

The dynamic group buying system will provide that ability for other users to vote for these products to be added to the optimized pricing campaign. If a user has a strong desire to attain a certain product at an optimal price, they can provide their contact information after voting. In the case where that product gets added onto an optimized pricing campaign, the user will get a notification and will be automatically added as a pledge for the product.

The voting process, as shown in FIG. 3, will enable the sellers to accurately gauge the user's demands by providing insights on what products users are interested in. Sellers can also participate in this process by posting several products in the voting page.

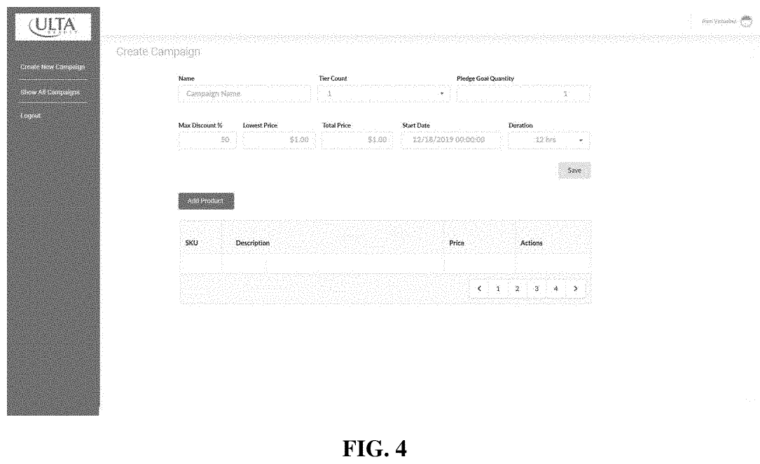

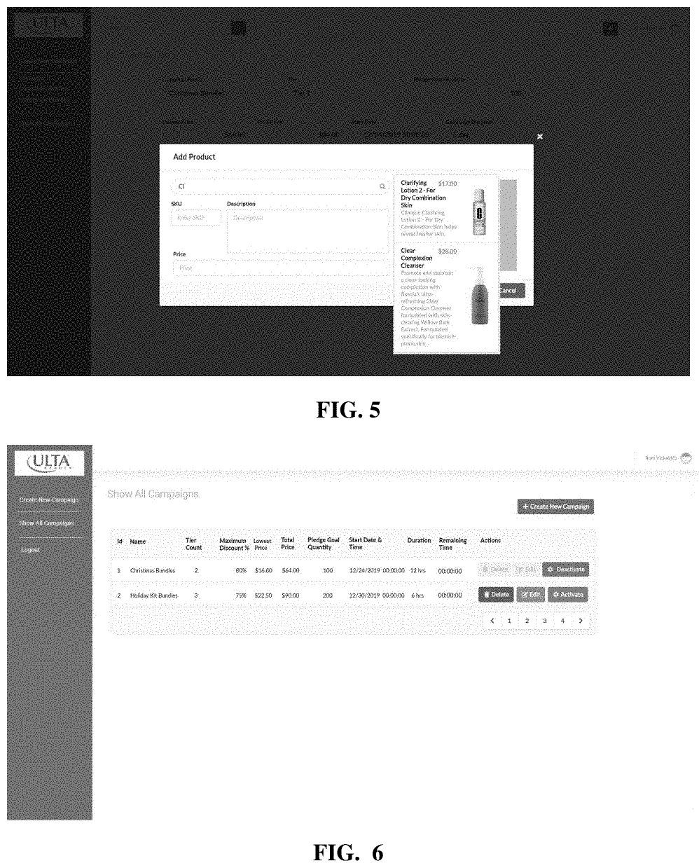

FIGS. 4-7 illustrate a graphical representation of webpages used to set up a dynamic group buying campaign and the main campaign pledge page for buyers to interact. FIG. 4 is the page used by the seller to create a campaign. The seller enters the campaign name, the tier count, the pledge goal quantity. The seller also enters the maximum discount percentage, the lowest sale price, the total price, the start date and duration of the campaign. The seller would also upload product information including photographs and product description, as shown in FIG. 5. The product description would include the sku, product description, and photographs of the product.

FIG. 6 is a display of an active campaign after the seller sets up and initiates a campaign. This page is viewable by the seller of the products but would not be viewable by the buyers. The display can show multiple products that have active campaigns. The campaign display page provides the name of the product, the tier count, the maximum discount, lowest price, pledge goal quantity, start date and time, duration, and remaining time. Seller can also delete, edit, activate, or deactivate a campaign on the campaign display page.

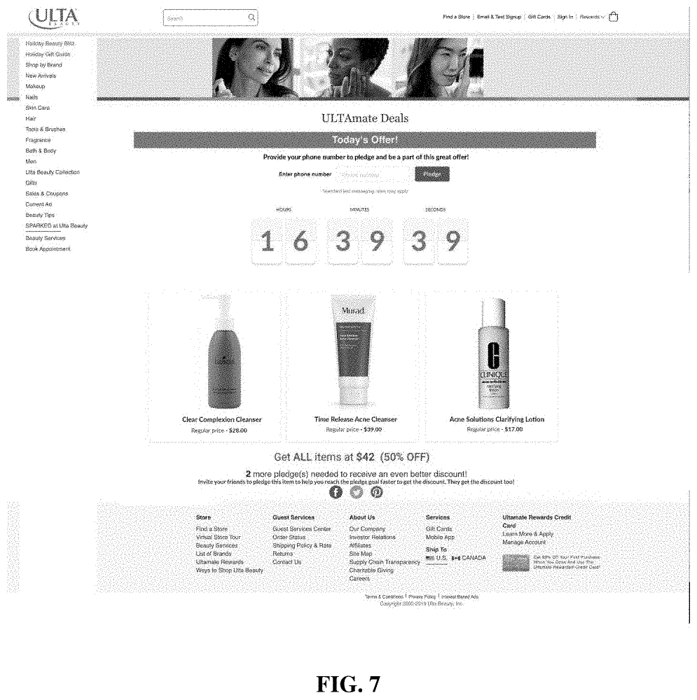

FIG. 7 illustrates the main campaign pledge web page for buyers. This page identifies the products that are part of the campaign, the amount of time left in the campaign, a text box for a buyer to enter personal information such as phone number or email address. This page also identifies the number of additional pledges needed to receive an even better discount and the current discount available if the pledge goal is achieved.

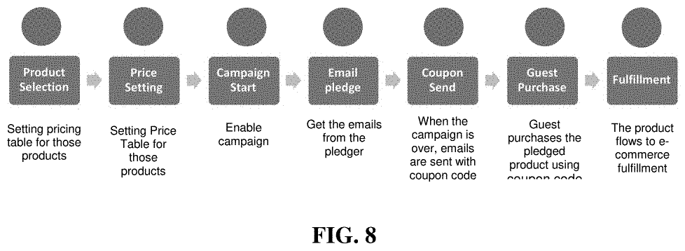

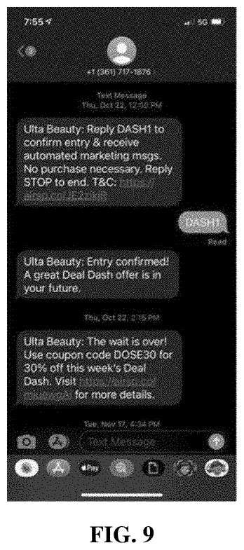

FIG. 8 is a flow chart that illustrates the dynamic pricing steps. The flow chart includes product selection, which is where a seller identifies the products that they wish to sell through use of a campaign. Then next step is for the seller to identify the pricing for which they want to sell the identified products and other limitations discussed herein. The system uses machine learning to determine the price point and the number of tiers that will be set forth in the campaign. The next step is to enable to campaign so that buyers are allowed to make pledges by sending in their email, phone number or other means to let the buyer know that they are making a pledge. At the end of the campaign, if one or more tiers are completed, a communication is sent to the buyers who made a pledge with a coupon code to allow the buyer to purchase the product at the discounted price. With the discount code, the buyer can then make the purchase from the seller, which is fulfilled through an e-commerce platform. FIG. 9 illustrates a notification sent to the buyers who made a pledge to purchase the product. The notification includes the discount code to be used by the buyer to purchase the product at the discounted price.

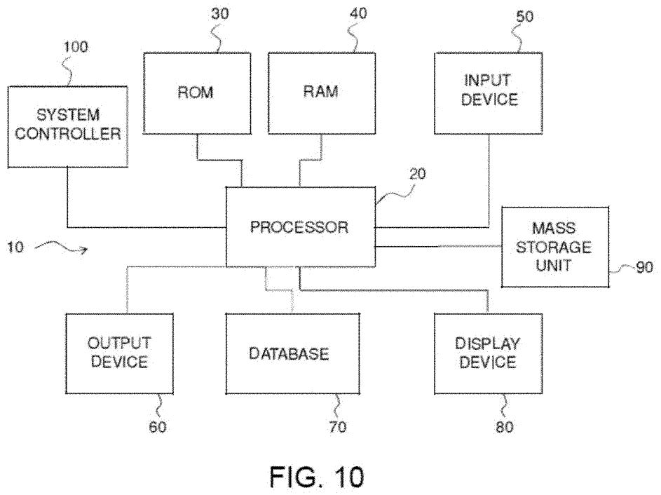

FIG. 10 illustrates a simplified block diagram representation of a terminal 10 for use in a system and method in accordance with the present invention is shown. The figure does not necessarily show all of the system's hardware and software modules, and omits many physical and logical connections which will be apparent to one of ordinary skill in the art after review of the present disclosure.

The terminal 10 can be a special purpose data processor, a general-purpose computer, smartphone, tablet, a computer system, or a group of networked computers or computer systems configured to perform the steps or modes of the methods of the invention. According to one aspect, the terminal 10 may built on a personal computer platform, such as a PC or a Mac computer or an Apple or Android smartphone. According to another aspect, the terminal 10 may communicate with a system controller 100. The system controller 100 can be a computer network within a client/server environment. According to yet another aspect, the system and method of the present invention may be implemented on the Internet, an intranet or an extranet.

A user input device 50 is used to enter data or commands using the terminal 10. The input device 50 can include, for example, the following mechanisms: a keyboard; a scanner; a user pointing device such as, for example, a mouse, a trackball, or a touch pad. As illustrated in FIG. 10, the user input device 50 may connected to the processor 20. The user input device 50 may be connected to the processor 20, for example, directly or through a local area network (LAN), through a wide area network (WAN) through a wired or wireless network, through the Internet, an intranet or an extranet.

Alternatively, the terminal 10 may also include a database 70 for storing the data that may be needed or desired in performing the method steps described herein. The database 70 can be a physically separate system coupled to the processor 20, as illustrated. In one version of the system 10, the processor 20 and the mass storage device 90 perform the functions of the database 70.

The terminal 10 can further include one or more output devices, for example, a display 50 and a printer. The one or more output devices may be located in a different location than the processor 20 and may be connected to the processor 20, for example, directly or through a local area network (LAN), through a wide area network (WAN) through a wired or wireless network, through the Internet, an intranet or an extranet. As explained above, the terminal 10 may be connected to a system controller 100

According to one aspect of the invention, the terminal 10 may be used by sellers to provide dynamic group discounting to buyers of products and/or services. As discussed herein, a number of different systems may be connected to a system control 100 which may allow a single seller to provide products and/or services to a plurality of buyers, each of the seller and the plurality of buyers communicating with each other through the system control 100.

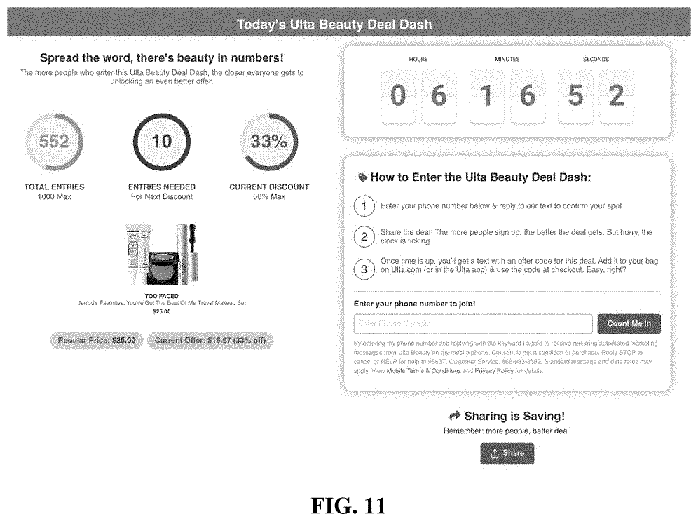

FIG. 11 a graphical illustration of a webpage display showing a full desktop landing page as an active campaign is in progress. The webpage shows the total entries in a graphical and numerical value, the number of entries needed for the next discount tier, and the current discount represented as a percentage. The webpage illustrates the product that is available for sale as well as the regular retail price and the current offer price in the current discount tier. The webpage also has a countdown timer for the campaign and has a share function to allow a buyer to share the campaign with fellow buyers. The webpage also provides instructions on how to enter the campaign and includes a textbox for the buyer to add their contact information.

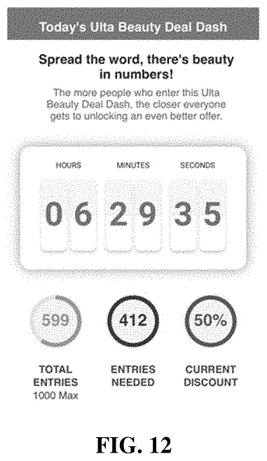

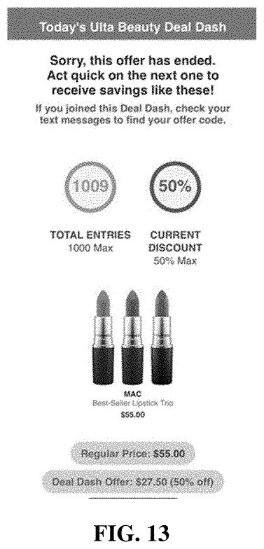

FIG. 12 is a graphical illustration of a mobile device display showing an abbreviated landing page, which provides some of the information available on the desktop landing page. This includes a countdown timer as well as the total entries, entries needed, and the current discount available. FIG. 13 is a graphical illustration of a mobile device display showing a campaign that has concluded and provides information on the product that was part of the campaign, the total number of entries, and the current discount. The display also provides the regular retail price as well as the discounted price available to those who pledged during the campaign.

The dynamic group buying and product pricing system includes an input device that is adapted to receive seller information from a seller, including seller information relating to a price and a quantity of product that is being offered for sale. The system also includes a machine learning system which creates an optimized price campaign for use by a group of buyers for the product.

The optimized price campaign including several tiers wherein each tier includes an assigned price point, a total number of pledges needed from the group of buyers to satisfy the price tier and a campaign expiration time. The system is configured to receive buyer information from the plurality of buyers each of which agrees to pay the price for the product when the total number of pledges for one or more of the price tiers is satisfied. The system is also configured for receiving buyer information so that the buyer can make pledges and be contacted at the end of the campaign.

The dynamic group buying system also including a tier progression system that can be activated for a set duration to allow the group of buyers to make pledges in the first price tier. If the group of buyers meet the total number of pledges required from the first price tier, then the group of buyers are eligible to receive the product at allotted price of the first price tier and qualify for the second price tier.

If the group of buyers meet the total number of pledges required for the second price tier, then the group of buyers are eligible to receive the product at the discounted price of the second price tier. The machine learning system uses neural network-based regression modelling to create, access and adjust pricing, and the number of tiers in a campaign. The system performs dynamic price generation through machine learning, which governs creation of an optimum configuration of prices, product allocation and duration of each price tier based off several parameters including time of year, purchase trends of a given product and interest velocity.

The machine learning system makes recommendations to the seller by generating time series data based on a neural network-based regression model predicting the popularity of the product campaign to allow the seller to decide on the right combination of the products for a product campaign and the optimum time to start the campaign. The machine learning includes a neural network-based self-learning mechanism to understand time series data and capture the hidden variables in which the system will observe past campaigns' performance to tune its internal configuration to optimize for maximum user reach and sales.

The system also includes a dynamic analytics system which is configured to observe the users voting habits in a product voting mechanism and the track the parameters of buyers sharing active product campaigns to aid the self-learning mechanism. The dynamic group buying system also includes a notification system where, after all tiers have been exhausted or the campaign duration is met, the system notifies the group of buyers if they meet the number of pledges required for the latest completed price tier provided to the group of buyers at the price corresponding to the latest price tier.

The machine learning system, of the present disclosure, allows preset input from the seller including a reserve quantity of products, a minimal sales price, a list price, a campaign duration, a number of campaign levels and a maximum price so that the configurations generated by the machine learning system stay within desired parameters. The system is integrated with social media platforms, SMS texting, and email to allow buyers to encourage other buyers to participate in the optimized price campaign.

The dynamic group buying and product pricing system is used for facilitating a sales transaction for purchasing a retail product by a group of buyers from at least one seller over an electronic network comprising a processor configured to execute a series of steps. First, the system receives into a dynamic price module, product information from the seller including a reserve quantity of product, a minimal sales price, a list price, a campaign duration, a number of campaign levels and a maximum price.

Next, the system utilizes machine learning to generate an optimized price campaign for use by the group of buyers, the optimized price campaign setting a first discount tier and a second discount tier. Each of the discount tiers includes a discounted price of the product and a total number of pledges needed from the group of buyers to satisfy the discount tier. The discounted price of the second discount tier is greater than the discounted price of the first discount tier. They system next activates the optimized price campaign for a set duration to allow the group of buyers to make pledges in the first discount tier.

If the group of buyers meet the total number of pledges required from the first discount tier, then the group of buyers are eligible to receive the product at the discounted price of the first discount tier and qualify for the second discount tier. If the group of buyers meet the total number of pledges required for the second discount tier, then the group of buyers are eligible to receive the product at the discounted price of the second discount tier. At the end of the campaign, the system notifies the group of buyers if they meet the number of pledges required for either the first or the second discount tier and provide the product to the group of buyers at the discounted price of the greatest number of tiers satisfied.

The embodiment(s) detailed hereinabove may be combined in full or in part, with any alternative embodiment(s) described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the present disclosure describes various exemplary embodiments, the disclosure is not so limited. To the contrary, the disclosure is intended to cover various modifications, uses, adaptations, and equivalent arrangements based on the principles disclosed. Further, this disclosure is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims.

1. A dynamic group buying and product pricing system comprising:
an input device for receiving seller information from a seller, including seller information relating to a price and a quantity of product that is being offered for sale,
a machine learning system which creates an optimized price campaign for use by a group of buyers for the product, the optimized price campaign including several tiers wherein each tier includes an assigned price point, a total number of pledges needed from the group of buyers to satisfy the price tier and a campaign expiration time,
the system is configured to receive buyer information from the plurality of buyers each of which agrees to pay the price for the product when the total number of pledges for one or more of the price tiers is satisfied,
the system configured for receiving buyer information so that the buyer can make pledges and be contacted at the end of the campaign.

2. The dynamic group buying and product pricing system of claim 1, further including a tier progression system that can be activated for a set duration to allow the group of buyers to make pledges in the first price tier, wherein if the group of buyers meet the total number of pledges required from the first price tier, then the group of buyers are eligible to receive the product at allotted price of the first price tier and qualify for the second price tier, and if the group of buyers meet the total number of pledges required for the second price tier, then the group of buyers are eligible to receive the product at the discounted price of the second price tier.

3. The dynamic group buying and product pricing system of claim 2, wherein the machine learning system uses neural network-based regression modelling to create, access and adjust pricing and the number of tiers in a campaign.

4. The dynamic group buying and product pricing system of claim 1, wherein the system performs dynamic price generation through machine learning, which governs creation of an optimum configuration of prices, product allocation and duration of each price tier based off several parameters including time of year, purchase trends of a given product and interest velocity.

5. The dynamic group buying and product pricing system of claim 4, wherein the machine learning makes recommendations to the seller by generating time series data based on a neural network-based regression model predicting the popularity of the product campaign to allow the seller to decide on the right combination of products for a product campaign and the optimum time to start the campaign.

6. The dynamic group buying and product pricing system of claim 5, wherein the machine learning includes a neural network-based self-learning mechanism to understand time series data and capture the hidden variables in which the system will observe past campaigns' performance to tune its internal configuration to optimize for maximum user reach and sales in future product campaigns.

7. The dynamic group buying and product pricing system of claim 6, further including a dynamic analytics system which is configured to observe the users voting habits in a product voting mechanism and the track the parameters of buyers sharing active product campaigns to aid the self-learning mechanism.

8. The dynamic group buying and product pricing system of claim 1, further including a notification system where after all tiers have been exhausted or the campaign duration is met, notify the group of buyers if they meet the number of pledges required for the latest completed price tier provide the product to the group of buyers at the price corresponding to the latest price tier.

9. The dynamic group buying and product pricing system of claim 1, wherein the machine learning system allows preset input from the seller including a reserve quantity of products, a minimal sales price, a list price, a campaign duration, a number of campaign levels and a maximum price so that the configurations generated by the machine learning system stay within parameters.

10. The dynamic group buying and product pricing system of claim 1, wherein the system is integrated with social media platforms, SMS texting, and email to allow buyers to encourage other buyers to participate in the optimized price campaign.

11. A dynamic group buying and product pricing system for facilitating a sales transaction for purchasing a retail product by a group of buyers from at least one seller over an electronic network comprising a processor configured to execute the steps of:
a. receiving into a dynamic price module, product information from the seller including a reserve quantity of product, a minimal sales price, a list price, a campaign duration, a number of campaign levels and a maximum price;
b. utilizing a machine learning system to generate an optimized price campaign for use by the group of buyers, the optimized price campaign setting a first discount tier and a second discount tier wherein each of the discount tiers includes a discounted price of the product and a total number of pledges needed from the group of buyers to satisfy the discount tier, wherein the discounted price of the second discount tier is greater than the discounted price of the first discount tier;
c. activating the optimized price campaign for a set duration to allow the group of buyers to make pledges in the first discount tier, wherein if the group of buyers meet the total number of pledges required from the first discount tier, then the group of buyers are eligible to receive the product at the discounted price of the first discount tier and qualify for the second discount tier, and if the group of buyers meet the total number of pledges required for the second discount tier, then the group of buyers are eligible to receive the product at the discounted price of the second discount tier; and
d. notifying the group of buyers if they meet the number of pledges required for either the first or the second discount tier and provide the product to the group of buyers at the discounted price of the greatest number of tiers satisfied.

12. The dynamic group buying and product pricing system of claim 11, wherein the machine learning system uses neural network-based regression modelling to create, access and adjust pricing and the number of tiers in a campaign.

13. The dynamic group buying and product pricing system of claim 11, wherein the system performs dynamic price generation through machine learning, which governs creation of an optimum configuration of prices, product allocation and duration of each price tier based off several parameters including time of year, purchase trends of a given product and interest velocity.

14. The dynamic group buying and product pricing system of claim 13, wherein the machine learning makes recommendations to the seller by generating time series data based on a neural network-based regression model predicting the popularity of the product campaign to allow the seller to decide on the right combination of the products for a product campaign and the optimum time to start the campaign.

15. The dynamic group buying and product pricing system of claim 14, wherein the machine learning includes a neural network-based self-learning mechanism to understand time series data and capture the hidden variables in which the system will observe past campaigns' performance to tune its internal configuration to optimize for maximum user reach and sales.

16. The dynamic group buying and product pricing system of claim 15, further including a dynamic analytics system which is configured to observe the users voting habits in a product voting mechanism and the track the parameters of buyers sharing active product campaigns to aid the self-learning mechanism.

17. The dynamic group buying and product pricing system of claim 11, further including a notification system where after all tiers have been exhausted or the campaign duration is met, notify the group of buyers if they meet the number of pledges required for the latest completed price tier provide the product to the group of buyers at the price corresponding to the latest price tier.

18. The dynamic group buying and product pricing system of claim 11, wherein the machine learning system allows preset input from the seller including a reserve quantity of products, a minimal sales price, a list price, a campaign duration, a number of campaign levels and a maximum price so that the configurations generated by the machine learning system stay within parameters.

19. The dynamic group buying and product pricing system of claim 11, wherein the system is integrated with social media platforms, SMS texting, and email to allow buyers to encourage other buyers to participate in the optimized price campaign.
